(19) United States
(12) Patent Application Publication
(10) Pub. No.: US 2019/0154173 A1
(43) Pub. Date: May 23, 2019

(54) LUMINOUS HOSE FOR TRANSPORTING USED FRACTURING LIQUID AND MANUFACTURING METHODS THEREOF

(71) Applicant: 5ELEM HI-TECH CORPORATION, TAIZHOU, JIANGSU (CN)

(72) Inventors: Yuehua SHA, TAIZHOU, JIANGSU (CN); Chundong GU, TAIZHOU, JIANGSU (CN); Shanhong ZHOU, TAIZHOU, JIANGSU (CN); Donghui WANG, TAIZHOU, JIANGSU (CN); Wenlin SHA, TAIZHOU, JIANGSU (CN); Yong JIANG, TAIZHOU, JIANGSU (CN)

(73) Assignee: 5ELEM HI-TECH CORPORATION, TAIZHOU, JIANGSU (CN)

(21) Appl. No.: 15/554,745

(22) PCT Filed: Mar. 6, 2017
(86) PCT No.: PCT/CN2017/075804

§ 371 Date: Aug. 31, 2017

(51) Int. Cl. F16L 11/12; G10K 5/00; G10K 9/00; B32B 1/08; B32B 27/12; B32B 25/10; B29C 48/153

(52) U.S. Cl. CPC F16L 11/12; G10K 5/00; G10K 9/00; F21V 33/00; B32B 27/12; B32B 25/10; B29C 48/153; B32B 1/08

(57) ABSTRACT

The present disclosure provides a hose for transporting used fracturing liquid and manufacturing method thereof. The hose may include an outer layer, an enhancement layer and an inner layer. The outer layer may include a first polymer. The enhancement layer may include a synthetic fiber. The inner layer may include a second polymer. The surface of the outer layer may include an alerting object. The alerting object may include at least one of a luminous layer, a light band, a reflective layer, an identification layer or a sound generating object. The luminous layer may include at least one of a strip-shaped luminous layer, a ring-shaped luminous layer or a spiral-shaped luminous layer, arranged on the outer surface of the outer layer.

### TECHNICAL FIELD

The present application relates to a hose, and more particularly, to a luminous hose for transporting used fracturing liquid, and a manufacturing method thereof.

### BACKGROUND

Hydrofracturing or hydraulic fracturing technology is a method of fracturing rocks by a pressurized liquid. The technology has become a preferable method for extracting and exploiting shale oil and gas, tight gas, tight oil, and coal seam gas. In a process of exploiting the shale oil and gas, fracturing liquid needs to be transported to the exploiting area. Also, when the hydrofracturing is completed, the used fracturing liquid may be transported to a wastewater treatment plant. The fracturing liquid or the used fracturing liquid is often transported in a long distance by a hose. The hose transportation has a particular advantage in a region with complex terrains.

However, the hose is difficult to be recognized in a field, especially at night. When the used fracturing liquid or waste water is transported to the wastewater treatment plant via the hose, it is important to warn and alert the approaching vehicles or workers to avoid crashing or breaking the hose that may lead to leaking of the waste water. In the meantime, it is required that the hose can indicate the road to field workers at night, and indicate a direction for field examinations.

### SUMMARY

According to one aspect of the present disclosure, a hose is provided. The hose may include an outer layer, an enhancement layer, and an inner layer. The outer layer may include a first polymer. The enhancement layer may include a synthetic fiber. The inner layer may include a second polymer. The outer layer may include an alerting object on the outer surface.

In some embodiments, the first polymer may be selected from a group comprising thermoplastic polyurethane (TPU), polyvinyl chloride (PVC), TPU/PVC blends, PVC/nitrile butadiene rubber (NBR) blends, acrylonitrile butadiene styrene, ethylene vinyl acetate, polyam ides, polyim ides, natural rubbers, modified natural rubbers and synthetic rubbers.

In some embodiments, the second polymer may be selected from a group comprising ethylene-propylene-diene monomer (EPDM) rubber, silicone-modified EPDM rubber, fluororubber, polyethylene, chlorinated polyethylene (CM), TPU, PVC, TPU/PVC blends, PVC/NBR blends, acrylonitrile butadiene styrene, ethylene vinyl acetate, polyamides, polyimides, natural rubbers, modified natural rubbers and synthetic rubbers.

In some embodiments, the synthetic fiber may be selected from a group comprising polyester filament yarn, aramid fiber, basalt fiber, asbestos fiber, vinyon fiber, polyethylene or polypropylene fiber, wood fiber, cotton fiber, jute fiber, carbon fiber and glass fiber.

In some embodiments, the alerting object may include at least one of a luminous layer, a light band, a reflective layer, an identification layer or a sound generating object.

In some embodiments, the luminous layer, the light band, the reflective layer or the identification layer may be strip-shaped, ring-shaped or spiral-shaped.

In some embodiments, the luminous layer may include at least one of a strip-shaped luminous layer, a ring-shaped luminous layer or a spiral-shaped luminous layer, arranged on the outer surface of the outer layer.

In some embodiments, the luminous layer may include at least one of the first polymer (e.g., TPU or PVC), luminous powder, Si-69 (silane) coupling agent, antioxidant or methylene diphenyl diisocyanate (MDI) curing agent.

In some embodiments, the sound generating object may include a wind whistle, a buzzer or a loudspeaker.

In some embodiments, the luminous layer may be formed by spraying luminous material on the surface of the outer layer, and the hose is formed by a co-extrusion method.

In some embodiments, the hose may further include a sensing device, wherein the sensing device may be configured to: determine whether surrounding environment meets a preset condition; and control the alerting object to execute a noticing operation based on a determination that the surrounding environment meets the preset condition.

In some embodiments, the preset condition may include the approaching of an object, a human, a vehicle or an animal, a change of light, a change of temperature or a change of humidity.

In some embodiments, the alerting object may be formed on the surface of the outer layer by a co-extrusion method.

In some embodiments, the hose may further include one or more flow gauges or one or more pressure meters.

According to another aspect of the present disclosure, a method of manufacturing a hose is provided. The method may include: weaving an enhancement layer, wherein the enhancement layer is tubular; and co-extruding, on the basis of the enhancement layer, a first polymer, a second polymer, and material of a luminous layer or a reflective layer to form the hose, wherein the first polymer may form an outer layer outside the enhancement layer, the second polymer may form an inner layer inside the enhancement layer, and the luminous layer or the reflective layer may be formed on the outer surface of the outer layer.

In some embodiments, the method may further include installing a light band, an identifying layer or a sound generating object on the hose.

According to another aspect of the present disclosure, a method of manufacturing a hose is provided. The method may include: co-extruding a first polymer with luminous material or reflective material to form an outer layer and a luminous layer or a reflective layer, respectively, wherein the luminous layer or the reflective layer is formed on the inner surface of the outer layer; forming an inner layer, wherein the inner layer includes a second polymer; weaving an enhancement layer, wherein the enhancement layer is tubular; connecting the outer layer with the luminous layer or the reflective layer formed thereon to the inner surface of the enhancement layer; reversing the outer layer and the enhancement layer, wherein the outer layer is on the outer surface of the enhancement layer, and the luminous layer or the reflective layer is on the outer surface of the outer layer after reversal; and connecting the inner layer to the inner surface of the enhancement after reversal.

### BRIEF DESCRIPTION OF THE DRAWINGS

In order to illustrate the technical solutions related to the embodiments of the present disclosure, brief introduction of the drawings referred to the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

FIG. 1 is a schematic diagram of a hose according to some embodiments of the present disclosure;

FIG. 2 is a section view of a hose according to some embodiments of the present disclosure;

FIG. 3 is a flowchart of a method for manufacturing a hose according to some embodiments of the present disclosure;

FIG. 4 is a schematic diagram of a co-extrusion method according to some embodiments of the present disclosure;

FIG. 5 is a flowchart of a method for manufacturing a hose according to some embodiments of the present disclosure;

FIG. 6 is a schematic diagram of a hose according to some embodiments of the present disclosure;

FIG. 7 is a schematic diagram of a rolled-up hose according to some embodiments of the present disclosure; and

FIG. 8 is a schematic diagram of connecting structures of the hose according to some embodiments of the present disclosure.

### DETAILED DESCRIPTION

In order to illustrate the technical solutions related to the embodiments of the present disclosure, brief introduction of the drawings referred to the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural references unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

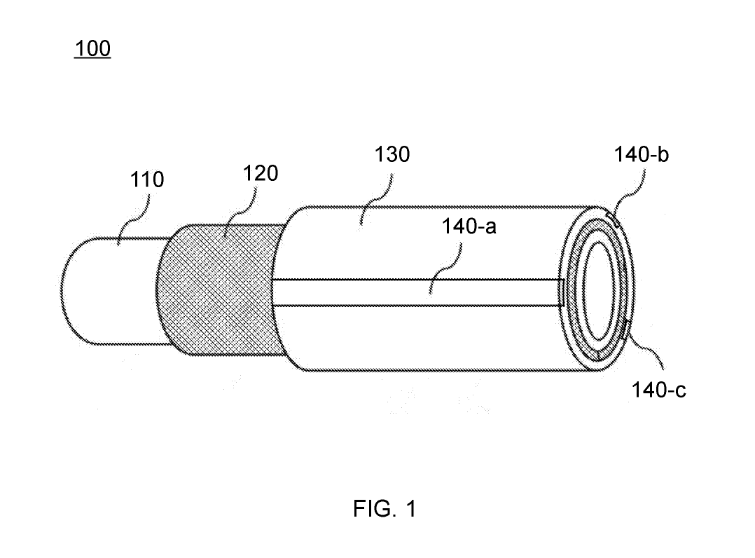

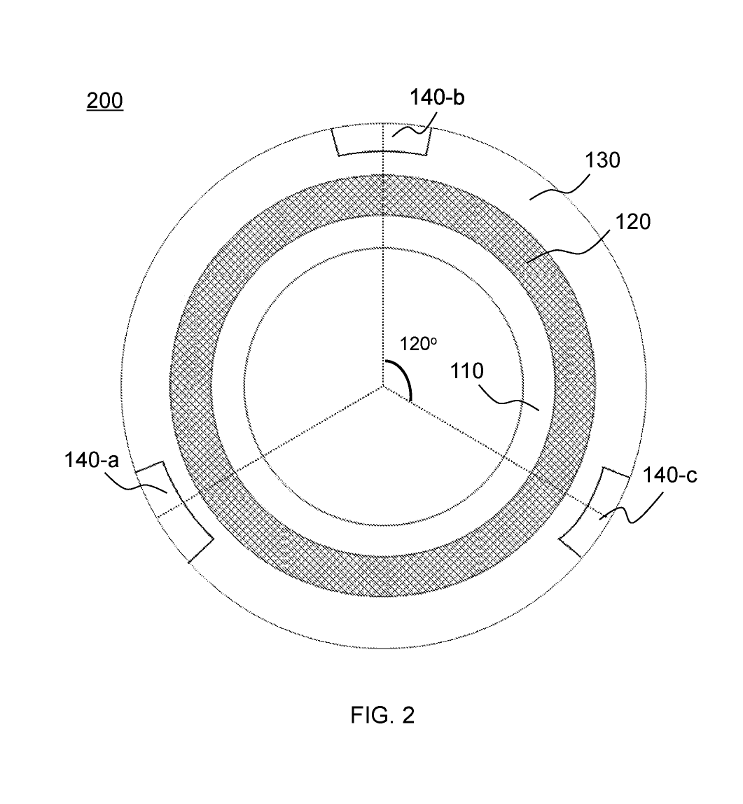

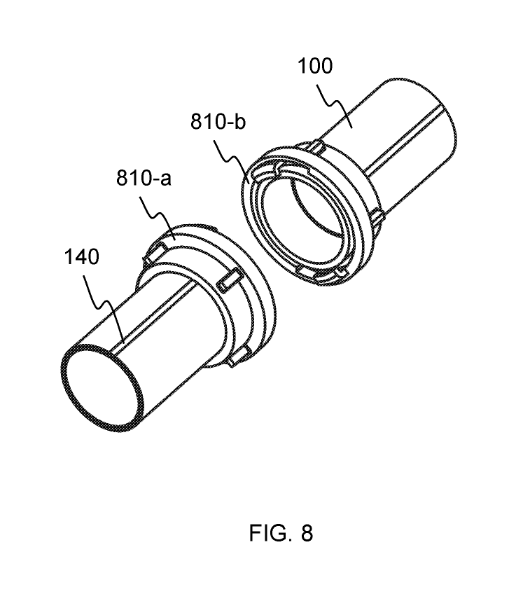

FIG. 1 is a schematic diagram of a hose according to some embodiments of the present disclosure. FIG. 2 is a section view of the hose according to some embodiments of the present disclosure. As shown in FIG. 1, a hose 100 may include an inner layer 110, an enhancement layer 120, an outer layer 130 and one or more luminous layers (fluorescent layers) or reflective layers 140 (e.g., 140-a, 140-b and 140-c). In some embodiments, additional layers may be added to the hose 100 without departing from the scope of the present disclosure. For example, an additional enhancement layer 120 may be added to the outer surface of the inner layer 110 or a protective layer may be added to the outer surface of the outer layer 130. In some embodiments, an anti-dust layer may be added to the outer surface of the outer layer 130. The anti-dust layer may have a smooth texture. Furthermore, an anti-static treatment may be performed on the surface of the anti-dust layer so that dust may not adhere to the surface of the anti-dust layer easily. In some embodiments, an anti-aging layer may be added to the surface of the outer layer 130. For example, a heat insulating polymer material, a corrosion-resisting material or a type of paint may be sprayed on the surface of the outer layer 130. In some embodiments, a flame retardant layer may be added to the surface of the outer layer 130. For example, a flame retardant material may be sprayed on the surface of the outer layer 130 or a flame retardant band may be installed on the surface of the outer layer 130. In some embodiments, at least one end of the hose 100 may include a connecting structure that may connect the hose to other components. The connecting structure may include buckle, screw thread, falcon structure, flange, etc. In some embodiments, one end of the hose 100 may be connected to a water cannon, and the other end of the hose 100 may be connected to a joint. The joint may connect two hoses 100 via their connecting structures. In some embodiments, multiple hoses 100 may be connected to each other via the connecting structures mentioned above. FIG. 8 is a schematic diagram of connecting structures of the hose according to some embodiments of the present disclosure. As shown in FIG. 8, multiple hoses 100 may be connected to each other via the connecting structures 810 (e.g., 810-a and 810-b).

As shown in FIG. 2, the height of the outer surface of the luminous layer or the reflective layer 140 may be consistent with the height of the outer surface of the outer layer 130. In some embodiments, the height of the outer surface of the luminous layer or the reflective layer may be higher or lower than the height of the outer surface of the outer layer 130. The cross section of the luminous layer or the reflective layer 140 may be polygon-shaped, fan-shaped, arc-shaped, tapered, ring-shaped, etc. In some embodiments, the luminous layer or the reflective layer 140 is in a shape of one or more strips. The one or more strips may be arranged in parallel to the axial direction on the surface of the outer layer 130. Based on such configuration, at least one strip-shaped luminous layer or the reflective layer may be seen from any perspective view. Further, the widths of the one or more strip-shaped luminous layers or the strip-shaped reflective layers 140 may be the same or different. The one or more strip-shaped luminous layers or the strip-shaped reflective layers 140 may be arranged in equal or different intervals on the outer surface of the outer layer 130. In some embodiments, the one or more strips of the luminous layer or the reflective layer 140 may intersect on the outer surface of the outer layer 130. In some embodiments, the one or more luminous layers or the reflective layers 140 may include the luminous layer, the reflective layer or both the luminous layer and the reflective layer.

In some embodiments, the inner diameter of the hose 100 may be 150-360 mm. More particularly, the inner diameter of the hose 100 may be 152 mm (6 inches), 203 mm (8 inches), 254 mm (10 inches), 305 mm (12 inches) or 356 mm (14 inches). Persons having ordinary skills in the art should understand that the inner diameter of the hose 100 may be adjusted according to different conditions.

When the fracturing liquid or the used fracturing liquid is transported via the hose 100, the inner layer 110 of the hose 100 may be in a direct contact with the fracturing liquid or used fracturing liquid, and therefore, there are certain requirements on the material of the inner layer 110. In some embodiments, the inner layer 110 may be made of a second polymer. More particularly, the second polymer may include a polymer with good chemical resistance and/or corrosion resistance. For example, the polymer may contain ingredients that have good resistance to the fracturing liquid. The chemical resistance may refer to a resistance ability of a material in an extreme chemical environment. More particularly, the chemical resistance may include resistances of acid, alkali, salt, solvent and other chemical substances. In some embodiments, the second polymer may include but not limited to polyurethane, polyvinyl chloride and its derivative(s), polythene and its derivative(s), rubber, resin and general polymer, amide polymer, imide polymer, etc. The polyurethane may include but not limited to thermoplastic polyurethane (TPU). The polyvinyl chloride and its derivative(s) may include but not limited to polyvinyl chloride (PVC), thermoplastic polyurethane/polyvinyl chloride (TPU/PVC) blend, polyvinyl chloride /acrylonitrile-butadiene rubber (PVC/NBR) blend, etc. The polythene and its derivative(s) may include but not limited to polythene, chlorinated polyethylene elastomer (CM), etc. The rubber may include but not limited to natural rubber, modified natural rubber, synthetic rubber, fluoride rubber, etc. For example, ethylene propylene diene monomer (EPDM), silicone modified EPDM rubber, polyolefin fluro rubber, nitroso fluoro rubber, tetrapropyl fluoro elastomer, phosphonitrile fluororubber, fluoroether rubber, etc. The resin and general polymer may include but not limited to acrylonitrile butadiene styrene copolymer, ethylene vinyl acetate copolymer, etc. The amide polymer or imide polymer may include but not limited to polyamide, polyimide. In some embodiments, the second polymer may include ethylene propylene diene monomer (EPDM) rubber. Comparing to TPU, EPDM may have a superior chemical stability and a broader range of working temperature. For example, EPDM may be used at a temperature below 40° C. It may be understood by persons having ordinary skills in the art that other rubbers or thermoplastic materials, or the like, may be used in the manufacturing and production of inner layer without departing from the scope of the present invention. In some embodiments, the inner layer 110 may have a thickness of 0.1-5.0 mm. Persons having ordinary skills in the art should understand that the thickness of the inner layer 110 may be adjusted according to different conditions.

The enhancement layer 120 may be arranged between the inner layer 110 and the outer layer 130. The enhancement layer 120 may enhance the flexibility of the hose 100, facilitate the hose 100 to bend, and extend the life of the hose 100. In some embodiments, the enhancement layer 120 may be woven on a loom. For example, the enhancement layer 120 may be woven on a loom using warp threads that are arranged longitudinally with respect to the enhancement layer 120 and the weft threads that are arranged helically along the enhancement layer 120. The enhancement layer 120 may include polyester filament yarn, aramid fiber, basalt fiber, asbestos fiber, vinyon fiber, polyethylene or polypropylene fiber, wood fiber, cotton fiber, jute fiber, carbon fiber, glass fiber, or the like, or any combination thereof. In some embodiments, the enhancement layer 120 may be woven using tubular fibrous warp threads and weft threads. In some embodiments, the enhancement layer 120 may be woven in other manners, including manual weaving, weaving with other devices, etc. The enhancement layer 120 may include at least one conductive metal thread. In some embodiments, the enhancement layer 120 may include but not limited to a thin copper thread. The thin copper thread may be woven in an axial direction on the enhancement layer 120 to improve the antistatic performance. In some embodiments, the enhancement layer 120 may have a thickness of 0.5-7.5 mm. Persons having ordinary skills in the art should understand that the thickness of the enhancement layer 120 may be adjusted according to different conditions.

In some embodiments, the outer layer 130 may be made of a first polymer. The first polymer may include a polymer with good wear resistance, corrosion resistance, and weather resistance. The wear resistance may refer to material's ability of resisting wears, including abrasive wear, adhesive wear (gluing), fatigue wear (pitting), corrosion wear, etc. Corrosion resistance may refer to the material's ability of resisting corrosion, including resistance of microorganisms, high temperature, and acid rain that may corrode the material. Weather resistance may refer to the material's resistance of a variety of outdoor environment factors, including light, temperature change, wind, rain, bacteria corruption, or other factors that may cause the aging of the material. The aging of the material may include color fade, color change, fracturing, pulverization and strength degradation.

In some embodiments, the first polymer may include but not limited to polyurethane, polyvinyl chloride and its derivative(s), rubber, resin and general polymer, amide polymer, imide polymer, etc. The polyurethane may include but not limited to thermoplastic polyurethane (TPU). The polyvinyl chloride and its derivative(s) may include but not limited to polyvinyl chloride (PVC), thermoplastic polyurethane/polyvinyl chloride (TPU/PVC) blend, polyvinyl chloride/acrylonitrile-butadiene rubber (PVC/NBR) blend, etc. The rubber may include but not limited to natural rubber, modified natural rubber, synthetic rubber, etc. The resin and general polymer may include but not limited to acrylonitrile butadiene styrene copolymer, ethylene vinyl acetate copolymer, etc. The amide polymer or imide polymer may include but not limited to polyamide, polyimide. The mass ratio for TPU/PVC blends may be TPU:PVC=100:0-70. The mass ratio of PVC to powdered NBR may be PVC:NBR=100:0-70, preferably 100:0-50. In some embodiments, the first polymer may be TPU. TPU may be a lightweight material that has good flexibility at low temperatures. TPU may also have good wear resistance, abrasion resistance, and weather resistance. It may be understood by persons having ordinary skills in the art that other rubbers or thermoplastic materials, or the like, may be used in the manufacturing and production of outer layer without departing from the scope of the present invention. In some embodiments, the outer layer 130 may have a thickness of 0.1-5.0 mm. Persons having ordinary skills in the art should understand that the thickness of the outer layer 130 may be adjusted according to different conditions. In some embodiments, the materials of the outer layer 130 and the inner layer 110 may be the same, for example, both the outer layer 130 and the inner layer 110 may be made of TPU. In some embodiments, the materials of the outer layer 130 and the inner layer 110 may be different.

In order to make the hose 100 found or identified more easily in the field, especially at night, a luminous layer or a reflective layer 140 may be arranged on the outer surface of the outer layer 130. By arranging the reflective layer 140 on the outer surface of the hose 100, the reflective layer 140 may reflect light with respect to a light source at night. For example, the reflective layer may reflect the moonlight, or the light generated by the light source. When a worker uses a torch, a car light, etc., to search for the hose, the reflective layer may cause the hose easier to be found or identified. By arranging the luminous layer 140 on the surface of the hose 100, the luminous layer may absorb the sunlight or the natural light during the day and then generate the light at night, hence making the hose easier to be found or identified.

Luminous effect of the luminous layer may be achieved by luminous powder (phosphor powder), such as a light induced energy storage powder. In some embodiments, the luminous powder may be sprayed directly on the surface of the outer layer 130, or be configured on the surface of the outer layer 130 by a co-extrusion method. In some embodiments, the material of the luminous layer may include the first polymer (e.g., TPU, PVC), luminous powder, coupling agent Si-69 (silane), antioxidant or curing agent methylene diphenyl diisocyanate (MDI) or the like, or any combination thereof. Such compositions may make the luminous layer and the surface of the outer layer 130 combine better. The material of the first polymer used by the luminous layer may be the same with the outer layer of the hose 130, which may make the luminous layer and the outer layer 130 bond easily. The coupling agent Si-69 (silane) may activate the surface of the luminous powder to increase the adhesion of the luminous powder and the outer layer 130. The antioxidant may improve the oxygen resistance and extend the life of the material. The curing agent MDI may increase the degree of cross-linking of the TPU at high temperatures, causing the TPU to produce a mesh structure, so that the luminous layer and the hose outer layer 130 may bond better. It should be noted that the components of the luminous layer mentioned above are only embodiments. It is easily understood by persons having ordinary skills that the components of the luminous layer may be increased, reduced, or replaced without departing from the scope of the present invention. In some embodiments, the reflective effect of the reflective layer may be achieved by a reflective material. The reflective material may include but not limited to glass bead reflective material, rare earth reflective material, micro-prism reflective material, etc.

In some embodiments, the luminous layer may have a thickness of 0.2-5.0 mm, the reflective layer may have a thickness of 0.1-3.0 mm. Persons having ordinary skills in the art should understand that the thickness of the luminous layer or the reflective layer 140 may be adjusted according to different conditions. In particular, the thickness of the luminous layer or the reflective layer 140 may have to be greater than a threshold to ensure its luminous or reflective effect. However, excessive thickness of the luminous layer or the reflective layer may cause a waste of material. The thickness of the luminous layer or the reflective layer 140 mentioned above may refer to the average thickness of the luminous layer or the reflective layer. When the luminous layer or the reflective layer 140 is configured on the outer surface of the outer layer via a co-extrusion method, the height of the luminous layer or the reflective layer 140 may be consistent with the height of the outer layer 130, or the height of the luminous layer or the reflective layer 140 may be higher or lower than the height of the outer layer 130.

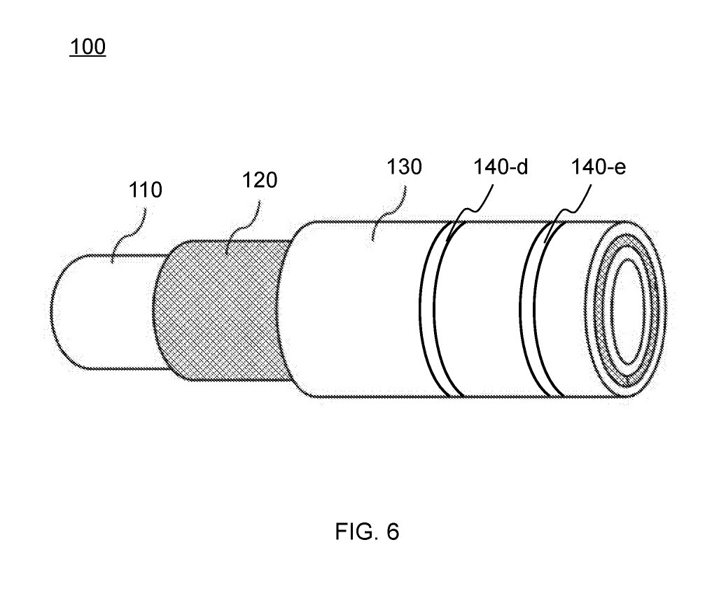

In some embodiments, the luminous layer or the reflective layer 140 may have various shapes, such as strip-shaped, spiral strip-shaped, ring-shaped, or the like. FIG. 6 is a schematic diagram of a hose according to some embodiments of the present disclosure. As shown in FIG. 6, the luminous layer or the reflective layer 140 (e.g., 140-d, 140-e) may be ring-shaped and configured on the surface of the outer layer 130 with certain intervals. In some embodiments, the luminous layer or the reflective layer 140 may have a shape including but not limited to a letter, a character, a symbol, or the like, or any combination thereof. For example, a LOGO, an arrow, etc., of a florescent material may be configured on the outer surface of the outer layer. In some embodiments, at least one strip-shaped luminous layer or strip-shaped reflective layer may be arranged along the axial direction of the outer layer 130 with equal intervals. Such configuration may make at least one luminous layer or reflective layer be seen from any perspective view. Besides, widths of the one or more strip-shaped luminous layers or the strip-shaped reflective layers 140 may be the same or different. In some embodiments, the strip-shaped luminous layers or the strip-shaped reflective layers 140 may be arranged in equal intervals or different intervals on the outer surface of the outer layer 130 along the axial direction of the hose 100. In some embodiments, at least one strip-shaped luminous layer or strip-shaped reflective layer may be arranged on the outer layer 130 with unequal intervals along the axial direction of the hose 100. In some embodiments, the strip-shaped luminous layer or strip-shaped reflective layer may intersect on the outer surface of the outer layer. In some embodiments, the luminous layer or the reflective layer 140 may be multiple strips or rings arranged in intervals. In some embodiments, the luminous layer or the reflective layer 140 may include the luminous layer, the reflective layer or both the luminous layer and the reflective layer. For example, the luminous layer or the reflective layer 140 may include at least one luminous layer, or at least one reflective layer. For another example, the luminous layer or the reflective layer 140 may include a combination of one or more luminous layers and one or more reflective layers. In some embodiments, the luminous layer or the reflective layer 140 may have different colors, including yellow, green, red, blue, white, or the like, or any combination thereof. In some embodiments, the luminous layer or the reflective layer 140 may be replaced by an identification layer. The identification layer may include but not limited to an identification line of bright color. The identification line may have no luminous or reflective function. The color of the identification layer may include yellow, green, red, blue, white, or the like, or any combination thereof. In some embodiments, a reflective film, such as a metal film, may be arranged on the surface of the outer layer of the hose to enhance the light reflection of the hose.

In some embodiments, a light-emitting device may be installed on the surface of the hose in addition to the luminous layer or the reflective layer 140. In some embodiments, the luminous layer or the reflective layer 140 may be replaced by the light-emitting device. The light-emitting device may include a light-emitting diode (LED) light band. The LED light band may include a plurality of LEDs arranged in equal intervals on the surface of the hose 100. The LED light band may be embedded on the surface of the outer layer 130 in a shape of a long strip, a spiral, etc. In some embodiments, the light-emitting device may be powered by a direct current (DC) power source, such as a battery. In some embodiments, the light emitting device may be powered by an alternating current (AC) power source, such as a power grid. In some embodiments, the light-emitting device or its battery may be powered by solar energy, wind energy, or kinetic energy of the liquid in the hose, or the like. Specifically, solar panels may be installed on the hose 100 for converting the solar energy into electric energy. Wind turbines may be installed on the hose 100 for converting the wind energy into electric energy. Besides, small-sized turbine generators may be configured at suitable positions inside the hose 100 to convert the kinetic energy of the liquid in the hose into electric energy. The electric energy mentioned above may supply power to the light-emitting device or its battery.

In some embodiments, a sound generating object may be installed on the surface of the hose in addition to the luminous layer or the reflective layer 140 on the hose. In some embodiments, part or all of the luminous layers or reflective layers may be replaced by the sound generating object. The sound generating object may include but not limited to a wind whistle, a buzzer or a loudspeaker, or the like, or any combination thereof. For example, one or more wind whistles may be installed on the surface of the hose. The wind whistles may produce sound for alerting and guidance when wind blows. As another example, one or more buzzers or loudspeakers may be configured on the surface of the hose. The buzzers or the loudspeakers may be powered by a DC power source, such as a battery or an alternating current power source, such as a power grid. In some embodiments, the buzzer, the speaker, or the battery may be powered by solar energy, wind energy, or kinetic energy of liquid in the hose. The buzzers or the loudspeakers may produce sound for alerting and guidance when powered on.

In some embodiments, a sensing device may be installed on the surface of the hose in addition to the luminous layer or the reflective layer 140 on the hose. The sensing device may be installed on the surface of the hose, near the hose, or at other suitable positions. In particular, the sensing device may be connected to the light-emitting device or the sound generating object in a wired or a wireless way. The sensing device may sense the changes of the surrounding environment, such as the approaches of people, animals, vehicles, etc., and the variations in temperature, humidity, air pressure, weather, etc. If the sensing device senses the change of the surrounding environment, it may generate a signal. The signal may control the light-emitting device or the sound generating object to respond accordingly. For example, for the purpose of alerting and guidance, the light-emitting device may emit light continuously or intermittently, the sound generating object may produce sound continuously or intermittently, or both the light-emitting device and the sound generating object may respond to the changes of the surrounding environment by generating the light and the sound, respectively. For example, the sensing device may control the light-emitting device to emit the light after a sensation of the night, and control the light-emitting device to stop the light emission after a sensation of the daytime.

In some embodiments, a hose without the luminous layer or the reflective layer 140 may be manufactured first. The luminous layer or the reflective layer 140 may then be formed by the luminous or reflective accessories configured on the hose. The luminous or reflective accessories may include but not limited to a luminous or reflective ring, a luminous or reflective tape, a luminous or reflective coating. One or more luminous or reflective ring may be placed on the surface of the hose in equal intervals. The luminous or reflective tape may be pasted on the surface of the hose in a shape of a long strip along the axial direction, or in a shape of a ring in a circumference direction of the hose.

In some embodiments, in order to prevent the hose from clogging due to twisting or folding or to limit the undesired rolling of the hose, a supporting structure may be attached to the hose. For example, a supporting frame may be attached to the surface of the hose. The supporting frame may be made of a rigid material and has a circular inner structure to accommodate the hose. By attaching the surface of the hose to the supporting frame, the hose may be kept plump, which may facilitate the transportation of the liquid inside the hose. In some embodiments, one or more supporting frames may be configured with certain intervals. The shape of the supporting frame may be configured to maintain a certain flow rate inside the hose, and can be any shape including square, oval, or other shapes. The surface of the hose may be fixed to the supporting frame by an adhesive agent, a squeezing method, etc. In some embodiments, in order to limit the random rolling of the hose, a supporting frame may be attached to the hose. For example, the supporting frame may be placed to the ground, and the hose that connects to the supporting frame may be positioned in a desired path. In some embodiments, the placement of the supporting frame and the hose may vary. For example, the supporting frame may be fixed to the hose, or the hose may be placed on the supporting frame. As another example, the supporting frame may not be fixed to the ground. For example, the supporting frame may be positioned on the ground and maintain its position relying on the friction between the supporting frame and the ground. Furthermore, the supporting frame may be connected to other objects such as walls, stones, etc.

In some embodiments, a monitor may be provided on the hose to monitor whether the hose is damaged or has leakage. The monitor may include but not limited to a flow gauge, a pressure meter, etc. For example, a plurality of flow gauges or pressure meters may be configured on the hose to measure the flow rate or the pressure of the fluid flowing in the hose at multiple locations. If the flow rates or pressures obtained between two flow gauges or pressure meters have a great difference, a leakage may exist in the section of the hose therebetween.

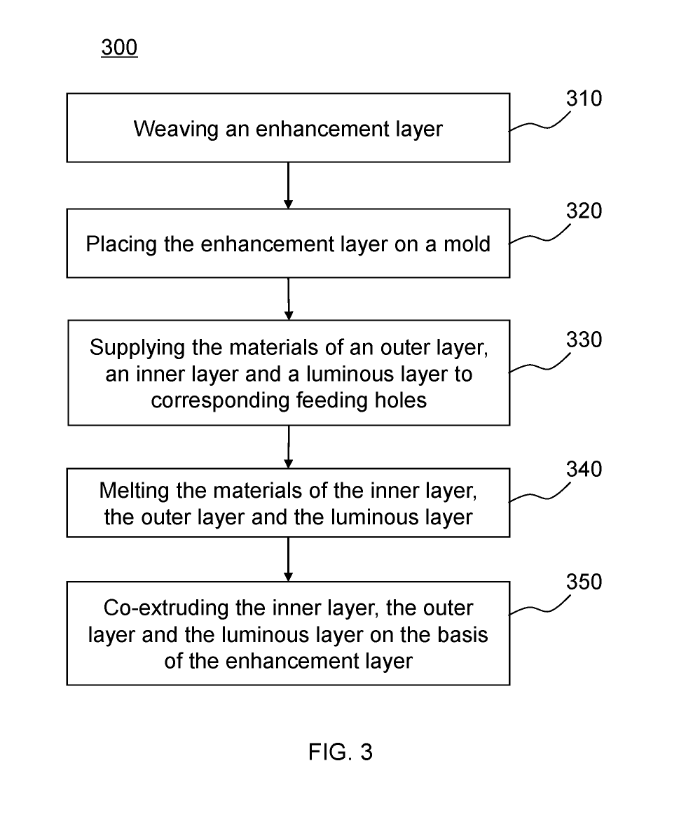

FIG. 3 is a flowchart of a method for manufacturing a hose according to some embodiments of the present disclosure.

In step 310, an enhancement layer may be woven. The enhancement layer may be woven on a loom with warp threads that are arranged longitudinally with respect to the enhancement layer 120 and weft threads that are arranged helically along the enhancement layer 120. In some embodiments, the enhancement layer may be woven with polyester filament yarn or basalt fiber. The enhancement layer 120 may have a thickness of 0.5-7.5 mm. Persons having ordinary skills in the art should understand that the thickness of the enhancement layer 120 may be adjusted according to different conditions.

In step 320, the enhancement layer 120 may be placed on a mold. The mold may be cylindrical. When the enhancement layer 120 is placed on the mold, an inner channel may be formed inside the enhancement layer 120, and an outer channel may be formed outside the enhancement layer 120.

In step 330, the materials of an inner layer 110, an outer layer 130 and a luminous layer (or a reflective layer) may be respectively supplied to the corresponding feeding holes. In some embodiments, the material of the inner layer 110 may be EPDM rubber, and the material of the outer layer may be TPU. The material of the luminous layer may include a first polymer (e.g., TPU, etc.), luminous powder, Si-69 (silane) coupling agent, or antioxidant or MDI curing agent. The caliber or the shape of the feeding holes may be adjusted according to various factors, including but not limited to a feature of the material of the inner layer, a feature of the material of the outer layer, feeding volume, etc. The inner layer 110 may have a thickness of 0.1-5.0 mm. The outer layer 130 may have a thickness of 0.1-5 mm. The luminous layer 140 may have a thickness of 0.2-5.0 mm. It should be understood for those skilled in the art, that the thickness of the inner layer 110, the outer layer 130 and the luminous layer 140 may be adjusted according to different situations.

In step 340, the material of the inner layer 110, the outer layer 130 and the luminous layer 140 may be melted.

In step 350, the melted materials of the inner layer, the outer layer and the luminous layer may be co-extruded on the basis of the enhancement layer. After the co-extrusion, the luminous layer may be formed on the surface of the outer layer along the axial direction of the hose. In some embodiments, the height of the luminous layer may be higher than the outer surface of the outer layer. In some other embodiments, the height of the luminous layer may be consistent with the height of the outer surface of the outer layer.

In the alternative, in step 350, the fluorescent powder may be sprayed on the surface of the melted outer layer. Then the outer layer with the sprayed fluorescent powder and the inner layer may be co-extruded on the basis of the enhancement layer.

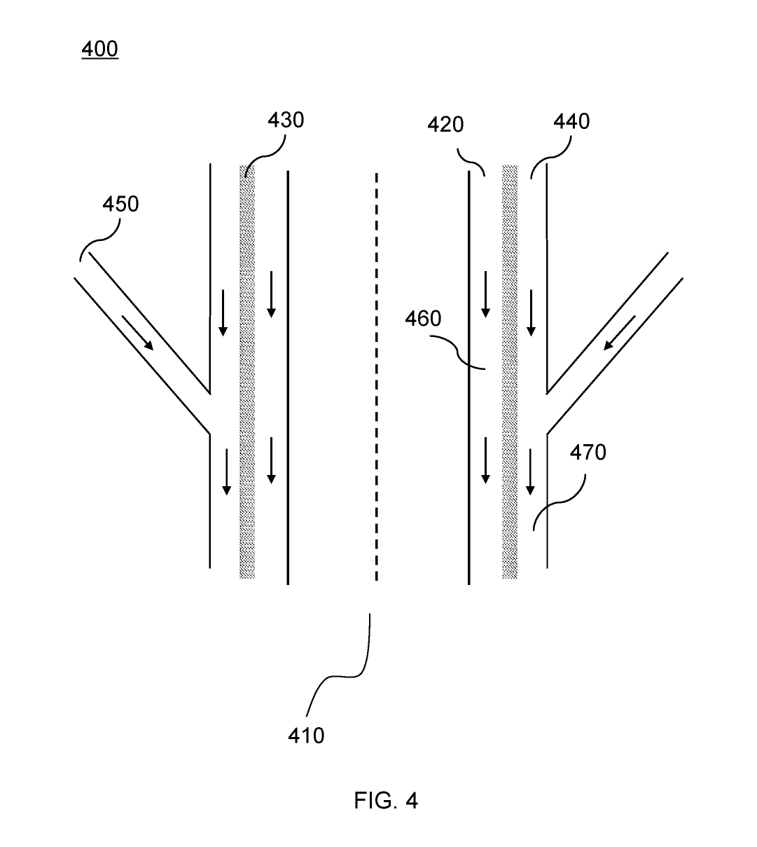

FIG. 4 is a schematic diagram of a co-extrusion method according to some embodiments of the present disclosure. As shown in FIG. 4, a co-extruding mold 400 may include a mold body 410, an inner layer feeding hole 420, an enhancement layer 430, an outer layer feeding hole 440, a reflective or luminous material feeding hole 450, an inner channel 460 and an outer channel 470. The mold body 410 may be cylindrical. The diameter of the mold body 410 may be equal to the inner diameter of the hose. When the hose is manufactured by a co-extrusion method, the enhancement layer 430 may be placed on the mold body 410. Then the inner layer channel 460 may be formed between the enhancement layer 430 and the mold body 410, the outer layer channel 470 may be formed between the enhancement layer 430 and outer wall of the mold 400. When manufacturing the hose, a melted first polymer may be fed into the outer layer channel 470 through the outer layer feeding hole 440, to form the outer layer of the hose. A melted second polymer may be fed into the inner layer channel 460 through the inner layer feeding hole 420, to form the inner layer of the hose. The melted reflective or luminous material may be fed into the outer layer channel 470 through the reflective or luminous material feeding hole 450, to form the luminous layer or the reflective layer on the surface of the outer layer. The three material feeding operations may be executed simultaneously or in sequence. In some embodiments, there may be three reflective or luminous material feeding holes 450 arranged 120 degrees from each other. In some embodiments, the mold body 410 may rotate along its center axis. In some embodiments, the angles between the reflective or luminous material feeding holes 450 may be different. Various patterns, such as stripes, spirals, laces, etc., of the luminous layer or the reflective layer may be formed along the axial direction of the hose by adjusting rotation speed of the mold body 410 and the angles between the reflective or luminous material feeding holes 450. In some embodiments, the widths of the reflective or luminous material feeding holes 450 may be same as or different from each other. In the co-extruding mold 400, the hose may be formed by co- extruding the first polymer, the second polymer, the reflective or luminous material on the basis of the enhancement layer. During the manufacturing process of the hose, a traction force may be applied on the hose to assist the manufacturing process. For example, the manufactured hose may be pulled out of the mold by a dragger so that the hose may be continuously manufactured.

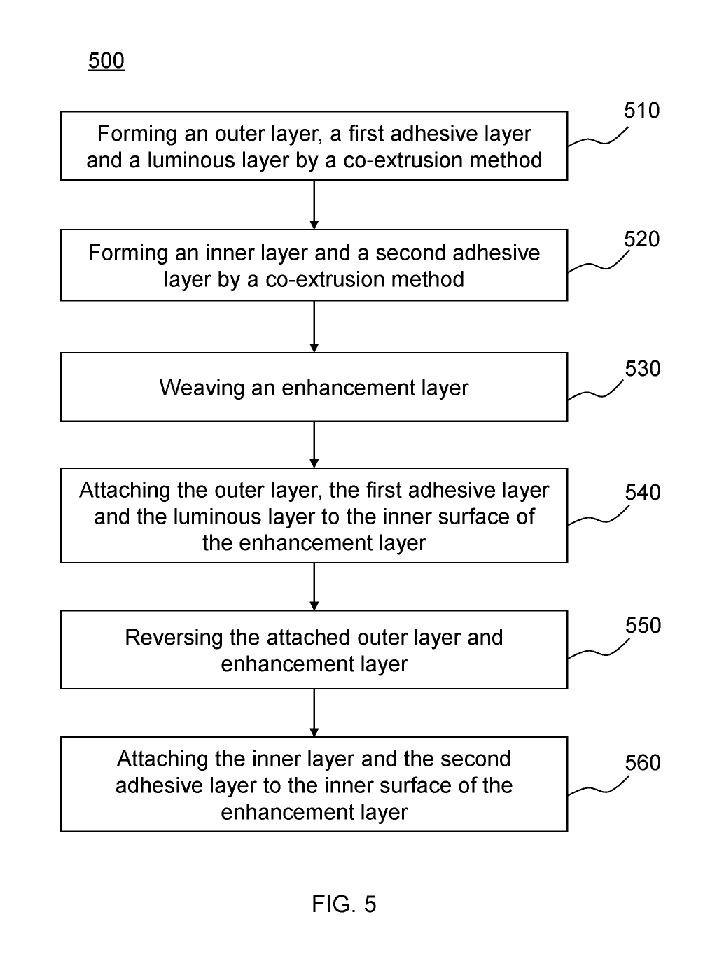

FIG. 5 is a flowchart of a method for manufacturing a hose according to some embodiments of the present disclosure.

In step 510, a first polymer, a first adhesive agent and a luminous material (or reflective material) may be co-extruded to form an outer layer, a first adhesive layer and a luminous layer (or reflective layer) of the hose. The luminous layer may be formed on the inner surface of the outer layer, and the first adhesive layer may be formed on the outer surface of the outer layer. Specifically, the temperature of the extruding operation of the first polymer may vary between 150-210° C. The temperature of the extruding operation of the first adhesive layer may vary between 140-175° C. In some embodiments, there may be three luminous material feeding holes arranged 120 degrees from each other. The first adhesive layer formed on the outer surface of the outer layer may bond the outer layer with the enhancement layer. The first adhesive layer may have a thickness of 0.10-0.35 mm. However, for those skilled in the art, the thickness of the first adhesive layer may be adjusted according to different conditions.

In step 510, fluorescent powder may be sprayed on the surface of the melted outer layer. Then, the outer layer with the sprayed fluorescent powder and the first adhesive layer may be co-extruded.

In step 520, a second polymer and a second adhesive agent may be co-extruded to form an inner layer and a second adhesive layer of the hose. The second adhesive layer may be formed on the outer surface of the inner layer. The second adhesive layer may have a thickness of 0.10-0.35 mm. However, for those skilled in the art, the thickness of the first adhesive layer may be adjusted according to different conditions. In addition, persons having ordinary skills in the art should also understand that the co-extrusion methods described in step 510 and 520 may be implemented by the co-extruding mold 400 or its variation. For example, in step 520, the feeding hole 450 of the co-extruding mold 400 may be omitted.

In step 530, a tubular enhancement layer may be woven. The weaving method may be described in connection with step 310. In some embodiments, the enhancement layer may be woven based on the product specification. In the manufacturing process, step 510, 520 and 530 may be executed in sequence or simultaneously.

In step 540, the outer layer, the first adhesive layer and the luminous layer may be attached to the inner surface of the enhancement layer. In the process of attaching, a curing agent may be added into the first adhesive layer. In some embodiments, the surface-treated outer layer (e.g., the outer layer with the luminous layer) and the first adhesive layer may be pulled into the tubular enhancement layer with both ends fixed and the first adhesive layer may be attached to the inner surface of the tubular enhancement layer. Further, steam of 0.10-0.35 MPa is delivered through the outer layer (that is inside the enhancement layer) for 4-10 minutes. Then the outer layer (with the luminous layer) and the enhancement layer may be cooled down to a desired temperature via air cooling instead of the steam with pressure maintained.

In step 550, the attached outer layer and enhancement layer (as describe in step 540) may be reversed. After the reversing operation, the outer layer may be outside the enhancement layer and the luminous layer may be on the outer surface of the outer layer.

In step 560, the inner layer and the second adhesive layer may be attached to the inner surface of the reversed enhancement layer. In some embodiments, the inner layer and the second adhesive layer, acquired in step 520, may be pulled into the reversed outer layer and enhancement layer, acquired in step 550, with both ends fixed and the second adhesive layer may be attached to the inner surface of the reversed enhancement layer. Further, steam of 0.10-0.35 MPa is delivered through the inner layer for 4-10 minutes. Then the hose may be cooled down to a desired temperature via air cooling instead of steam with pressure maintained.

In some embodiments, the material of the first adhesive agent may be hot-melt TPU adhesive agent, and the material of the second adhesive agent may be EVA modified plastics or aramid fiber. In some embodiments, the curing agent may be methylene diphenyl diisocyanate (MDI).

In some embodiments, masterbatch may be added into the first polymer and/or the second polymer described in step 510 and/or step 520.

In some embodiments, after step 510 and 520 are completed, the outer surface of the outer layer and the inner surface of the inner layer may be treated. The treatment method may include rinsing, polishing, steeping in specific solution to execute physical osmosis. The physical osmosis may include steeping the outer layer and the inner layer respectively into a solution mixed by curing agent and solvent with a certain ratio. The curing agent may be a material with a -NCO group. The solvent may include but not limited to organic solvent including ethyl acetate, ethyl alcohol, methylbenzene, hexane, or the like, or any combination thereof. The ratio of the curing agent and the solvent may be changed according to various materials of the outer layer and the inner layer. The surface treatment of the outer layer and the inner layer may be the same or different.

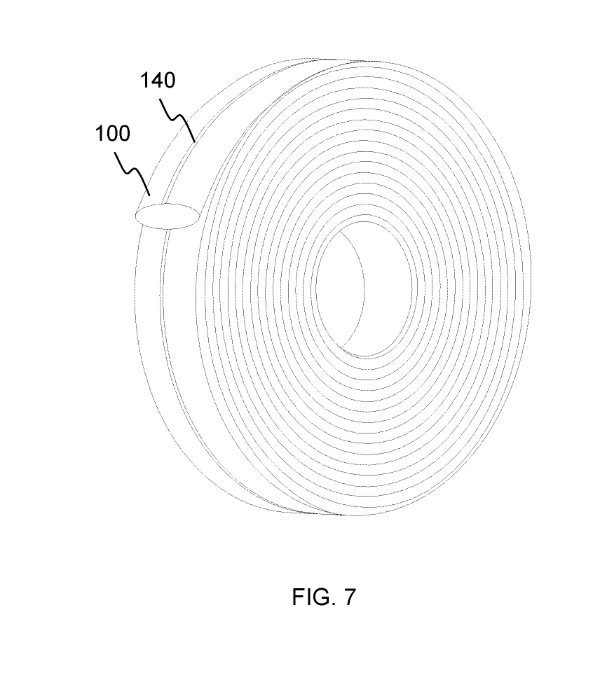

The hose of the present disclosure may be used for transporting fracturing liquid and/or used fracturing liquid in a hydrofracturing process of exploiting the shale oil and gas. Additionally, the hose may also be used for transporting other substances. For example, the hose may be used for transporting liquid, including but not limited to water, sewage, oil, gel, or the like. As another example, the hose may be used for transporting gas, including but not limited to coal gas, natural gas, pressurized air, poisonous gas, or the like. The hose may also be used for transporting solid in a particular condition. The luminous layer or the reflective layer may be applied in other fields, including but not limited to cable, optical cable, water pipe, oil pipe, or the like. FIG. 7 is a schematic diagram of a rolled-up hose according to some embodiments of the present disclosure. As shown in FIG. 7, the hose 100 may be rolled up to a disc-shape to be stored so that the storage space may be reduced. The rolled-up hose may be convenient for storage, preserving and transporting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

We claim:

1. A hose, comprising:
an outer layer, wherein the outer layer comprises a first polymer;
an enhancement layer, wherein the enhancement layer comprises a synthetic fiber; and
an inner layer, wherein the inner layer comprises a second polymer,
wherein the outer surface of the outer layer includes an alerting object.

2. The hose of claim 1, wherein the first polymer is selected from a group comprising thermoplastic polyurethane (TPU), polyvinyl chloride (PVC), TPU/PVC blends, PVC/nitrile butadiene rubber (NBR) blends, acrylonitrile butadiene styrene, ethylene vinyl acetate, polyamides, polyimides, natural rubbers, modified natural rubbers and synthetic rubbers.

3. The hose of claim 1, wherein the second polymer is selected from a group comprising ethylene-propylene-diene monomer (EPDM) rubber, silicone-modified EPDM rubber, fluororubber, polyethylene, chlorinated polyethylene (CM), TPU, PVC, TPU/PVC blends, PVC/NBR blends, acrylonitrile butadiene styrene, ethylene vinyl acetate, polyamides, polyimides, natural rubbers, modified natural rubbers and synthetic rubbers.

4. The hose of claim 1, wherein the synthetic fiber is selected from a group comprising polyester filament yarn, aramid fiber, basalt fiber, asbestos fiber, vinyon fiber, polyethylene or polypropylene fiber, wood fiber, cotton fiber, jute fiber, carbon fiber and glass fiber.

5. The hose of claim 1, wherein the alerting object comprises at least one of a luminous layer, a light band, a reflective layer, an identification layer or a sound generating object.

6. The hose of claim 5, wherein the luminous layer is strip-shaped, ring-shaped or spiral-shaped.

7. The hose of claim 6, wherein the luminous layer includes at least one of a strip-shaped luminous layer, a ring-shaped luminous layer or a spiral-shaped luminous layer, arranged on the outer surface of the outer layer.

8. The hose of claim 5, wherein the luminous layer includes at least one of the first polymer, luminous powder, Si-69 (silane) coupling agent, antioxidant or MDI curing agent.

9. The hose of claim 5, wherein the sound generating object includes a wind whistle, a buzzer or a loudspeaker.

10. The hose of claim 5, wherein the luminous layer is formed by spraying luminous material on the surface of the outer layer, and the hose is formed by a co-extrusion method.

11. The hose of claim 1, further comprising a sensing device, wherein the sensing device is configured to:
determine whether surrounding environment meets a preset condition; and
control the alerting object to execute a noticing operation based on a determination that the surrounding environment meets the preset condition.

12. The hose of claim 11, wherein the preset condition includes the approaching of an object, a human, a vehicle or an animal, a change of light, a change of temperature or a change of humidity.

13. The hose of claim 1, wherein the alerting object is formed on the outer surface of the outer layer by a co-extrusion method.

14. The hose of claim 1, further comprising one or more flow gauges or one or more pressure meters.

15. A method of manufacturing a hose, comprising:
weaving an enhancement layer, wherein the enhancement layer is tubular; and
co-extruding, on the basis of the enhancement layer, a first polymer, a second polymer, and material of a luminous layer or a reflective layer to form the hose,
wherein the first polymer forms an outer layer outside the enhancement layer, the second polymer forms an inner layer inside the enhancement layer, and the luminous layer or the reflective layer is formed on the outer surface of the outer layer.

16. The method of manufacturing a hose of claim 15, wherein the luminous layer includes at least one of a strip-shaped luminous layer, a ring-shaped luminous layer and a spiral-shaped luminous layer, arranged on the outer surface of the outer layer.

17. The method of manufacturing a hose of claim 15, further comprising:
installing a light band, an identification layer or a sound generating object on the hose.

18. The method of manufacturing a hose of claim 15, wherein the sound generating object comprises at least one of a wind whistle, a buzzer or a loudspeaker.

19. A method of manufacturing a hose, comprising:
co-extruding a first polymer with luminous material or reflective material to form an outer layer and a luminous layer or a reflective layer, respectively, wherein the luminous layer or the reflective layer is formed on the inner surface of the outer layer;
forming an inner layer, wherein the inner layer includes a second polymer;
weaving an enhancement layer, wherein the enhancement layer is tubular;
connecting the outer layer with the luminous layer or the reflective layer formed thereon to the inner surface of the enhancement layer;
reversing the outer layer and the enhancement layer, wherein the outer layer is on the outer surface of the enhancement layer, and the luminous layer or the reflective layer is on the outer surface of the outer layer after reversal; and
connecting the inner layer to the inner surface of the enhancement layer after reversal.

20. The method of manufacturing a hose of claim 19, wherein the luminous layer includes at least one of a strip-shaped luminous layer, a ring-shaped luminous layer and a spiral-shaped luminous layer, arranged on outer the surface of the outer layer.
